(19) United States
(12) Patent Application Publication
(10) Pub. No.: US 2018/0006843 A1
(43) Pub. Date: Jan. 4, 2018

(54) METHOD FOR ROUTING DATA BETWEEN A TETHERED DEVICE AND MULTIPLE PACKET DATA NETWORKS

(71) Applicant: MOTOROLA SOLUTIONS, INC, Schaumburg, IL (US)

(72) Inventors: ELENA LEVIN, GIVATAIM (IL); DAVID BAR-ON, REHOVOT (IL)

(21) Appl. No.: 15/198,529

(22) Filed: Jun. 30, 2016

(51) Int. Cl. H04L 12/46; H04L 12/24; H04L 29/12

(52) U.S. Cl. CPC H04L 12/4679; H04L 61/2567; H04L 61/2061; H04L 41/0806; H04L 61/2007; H04L 61/1511; H04L 61/2038

(57) ABSTRACT

A method is provided for routing data between a tethered device and multiple Packet Data Networks (PDNs) by a modem device. The modem device creates routing rules between the tethered device and the PDN. The modem device creates a Virtual Local Area Network (VLAN) that corresponds to the connection. The modem device also assigns an Internet Protocol (IP) address for the VLAN on the tethered device and assigns a Domain Name System (DNS) address of the PDN for the VLAN. The modem device sends an assign IP to interface command that includes the assigned IP address and the DNS address to the tethered device. The tethered device creates a VLAN network interface that corresponds to the VLAN on the tethered device. The received IP address and DNS address are assigned to the VLAN at the tethered device.

### BACKGROUND OF THE INVENTION

Public Safety Long Term Evolution (LTE) and Broadband networks typically include multiple Access Point Names (APNs) of Packet Data Networks (PDNs). The data from several applications is typically routed to a specific PDN and not to a default PDN.

Applications running on the mobile devices in these networks usually use standard operating system mechanisms to route data to the proper PDN.

Tethered devices are devices that are connected to another device and utilize the Internet connection of the other device. Tethering can be accomplished via wireless connection such as LAN (Wi-Fi), Bluetooth, or a physical connection such as USB (Universal Serial Bus).

One problem for tethered devices is that data from applications running on tethered devices are directed to only one PDN connection. There is no mechanism currently to route data from a tethered device to more than one PDN.

Therefore a need exists for an improved method for connecting a tethered device to a specific PDN, and more particularly to multiple PDNs.

### BRIEF DESCRIPTION OF THE SEVERAL VIEWS OF THE DRAWINGS

The accompanying figures, where like reference numerals refer to identical or functionally similar elements throughout the separate views, which together with the detailed description below are incorporated in and form part of the specification and serve to further illustrate various embodiments of concepts that include the claimed invention, and to explain various principles and advantages of those embodiments.

FIG. 1 is a system diagram illustrating a wireless network for routing data between a tethered device and a specific PDN in accordance with an exemplary embodiment of the present invention.

FIG. 2 illustrates a flow chart setting forth process steps for initial configuration and connection establishment between a tethered device and a modem device in accordance with an exemplary embodiment of the present invention.

FIG. 3 illustrates a flow chart setting forth process steps for a tethered device to request a PDN connection establishment in accordance with an exemplary embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

Disclosed is an improved method and device for routing data between a tethered device and a specific Packet Data Network (PDN) by a modem device. A connection is established between the modem device and the PDN. The modem device creates a Virtual Local Area Network (VLAN) corresponding to the connection and assigns an Internet Protocol (IP) address for the VLAN on the tethered device. The modem device sends a DNS address corresponding to the required PDN connection to the tethered device, and the tethered device builds an association between the VLAN interface corresponding to the PDN connection and the received DNS IP address. The modem device sends an assign IP to interface command to the tethered device. The assign IP to interface command includes the assigned IP address and the DNS address or addresses. The modem device creates a VLAN and sends a command to the tethered device to create a VLAN interface corresponding to the network. When this is successfully accomplished the modem device sends an assign IP (and DNS-s) to interface command to the tethered device. The tethered device creates a VLAN network interface corresponding to the VLAN. The tethered device assigns an IP address to the VLAN. Tethered device assigns an IP address to VLAN interface and not to the network itself. In accordance with an exemplary embodiment, data may be routed between the tethered device and the modem device via the VLAN, and data between the modem device and the PDN can be routed using various means. An exemplary embodiment allows a tethered device and a modem device to create a new VLAN, to assign a separate IP address to this VLAN interface on the tethered device, and to route traffic from a specific VLAN to a specific PDN.

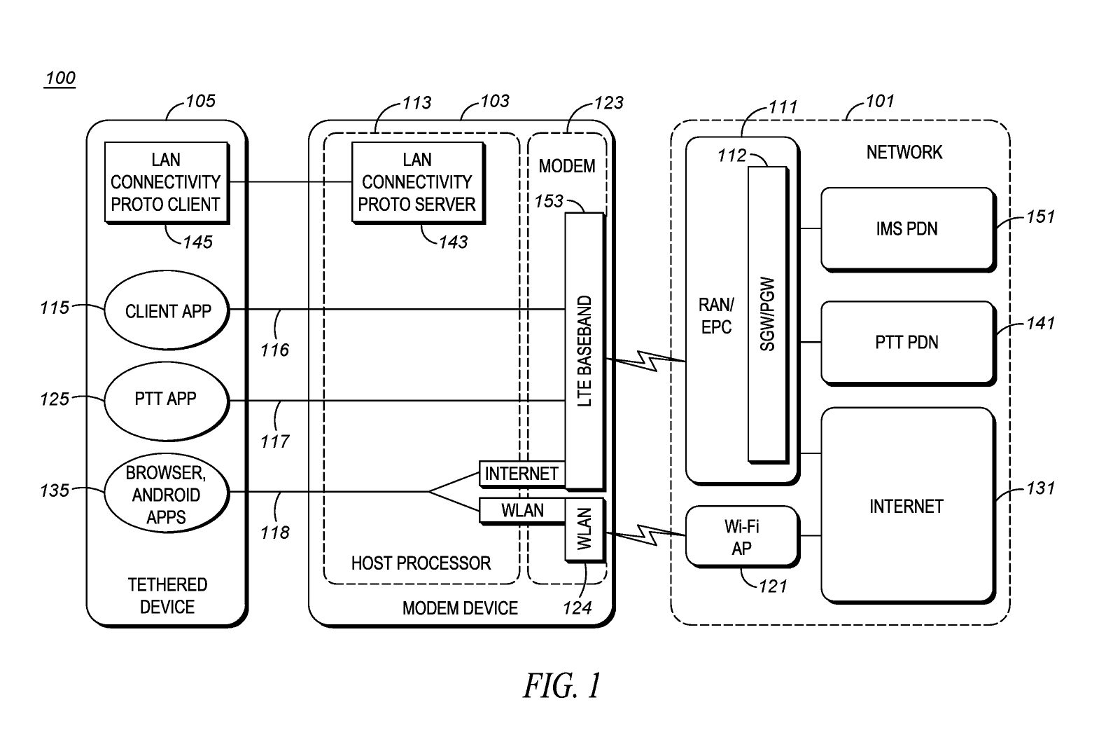

Referring now to the figures, and in particular FIG. 1, a system diagram illustrates a system 100 that includes a network 101, a Modem Device 103, and a tethered device 105.

Network 101 includes Radio Access Network/Evolved Packet Core (RAN/EPC) 111, Wi-Fi Access Point (AP) 121, Internet 131, PTT PDN 141, and IMD PDN 151. Internet 131 includes a VPN server, an application server, and a DNS, and is operably coupled to RAN/EPC 111 and Wi-Fi AP 121.

RAN/EPC 111 preferably includes a Serving Gateway/PDN Gateway (SGW/PGW) 112, a Mobility Management Entity (MME), a Home Subscriber Server (HSS), and an Evolved Packet Data Gateway (ePDG). In FIG. 1, only SGW/PGW 112 is shown for clarity. It should be understood that other cellular technologies could be utilized within the scope of this invention, including those that provide multiple APN access.

SGW/PGW 112 deal with the user plane. SGW/PGW 112 routes and forwards user data packets between the mobile devices and external networks, manages and stores mobile device contexts, performs replication of user traffic in case of lawful interception, performs policy enforcement, packet filtering for each user, IP address and IP prefix allocation, charging support, and packet screening. A mobile device may have simultaneous connectivity with more than one PGW for accessing multiple PDNs, or may alternately connect with a single PGW that provides access to multiple PDNs. These gateways may be combined in a single piece of network hardware or may be separate network elements.

The MME is responsible for idle mode mobile device paging and tagging procedure including retransmissions and also is involved in the bearer activation/deactivation process. The MME is also responsible for choosing the SGW for a mobile device at the initial attachment. The MME authenticates users via interaction with the HSS.

The HSS is a central database that contains user-related and subscription-related information. The HSS provides mobility management, call and session establishment support, user authentication and access authorization.

The ePDG secures data transmission with a mobile device connected to the EPC over an untrusted non-3GPP access method.

Wi-Fi AP 121 is a networking device that allows a Wi-Fi compliant device, such as Modem Device 103, to connect to an IP network, such as Internet 131. The network can be a wired network, a wireless network, or a combination of wired and wireless technologies.

PTT PDN 141 is a packet data network that provides push-to-talk services within network 101. PTT PDN 141 preferably includes a PIT server that facilitates PTT features and functionality.

IMS PDN 151 is an IP Multimedia Subsystem for delivering IP multimedia services, such as voice over IP calls.

Modem Device 103 includes Host Processor 113 and Modem 123. Modem Device 103 provides communication between tethered device 105 and network 101. Host processor 113 provides management functions and connection to tethered device 105. Host processor comprises LAN Connectivity Proto Server 143. Host processor 113 provides routing functionality from the VLAN corresponding to the PDN connection or default route connection to the modem device network interface corresponding to the PDN connection and vice versa.

Tethered device 105 is a mobile device that can communicate with Modem Device 103. Tethered device 105 preferably includes Client App 115, PIT App 125, Browser App 135, and Local Area Network (LAN) Connectivity Proto Client 145.

Client App 115 is a computer program designed to run on mobile devices. For example, Client App 115 can be a Push-to-talk (PTT) Client App that provides PTT service to tethered device 105. In accordance with an exemplary embodiment, Client App 115 is an API for triggering PDN connectivity. Client App 115 sends and receives data to and from modem 123 via LAN Connectivity Proto App 145, which passes through a network interface in host processor 113.

PTT App 125 is a client-server software application that provides functions, such as a broadband PTT client, for tethered device 105. PTT App 125 is connected to modem 123 via logical connection 117, which is preferably an Ethernet connection, which passes through a routing network interface in host processor 113. When connecting to network 101 using Wi-Fi, data is routed through WLAN 124, which transmits data over the air to Wi-Fi AP 121, preferably using the 802.11 protocol. When connecting to network 101 using cellular service, data is routed through LTE Baseband 153, preferably by using a radio bearer and an over the air signal to an EPC bearer located within RAN/EPC 111.

Browser App 135 is a software application that allows tethering device 105 to locate, retrieve, and display content from web pages located on Internet 131. Browser App 135 is connected to modem device 103 via interface 118. It should be understood that Browser App 135 can be a software application relating to any of a multitude of areas.

Local Area Network (LAN) Connectivity Proto Client 145 is a client-server software application that assists in providing connectivity to Modem Device 103

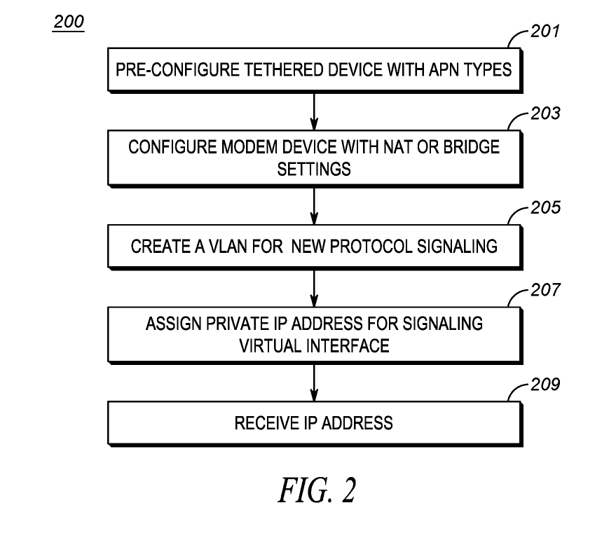

FIG. 2 illustrates a flow chart 200 setting forth process steps for initial configuration and connection establishment between a tethered device and a modem device in accordance with an exemplary embodiment of the present invention.

Modem Device 103 pre-configures (201) tethered device 105 with APN types. In accordance with an exemplary embodiment, tethered device 105 is preconfigured with predetermined types, preferably by device manufacture. Network types are used in communication between LAN connectivity Proto Client 145 and a server to trigger the corresponding PDN connection and to receive the network and binding events associated with the required PDN connection.

Modem Device 103 is configured (203) with NAT or bridge settings per Network (APN) type. For example, in a NAT scenario a DHCP range is allocated for every PDN connection.

Tethered Device 105 establishes a connection between tethered device 105 and Modem Device 103. In accordance with an exemplary embodiment, LAN Connectivity Proto Client 145 sends a broadcast message (or messages) to find a possible server in order to receive an IP address. Therefore, the connection between LAN Connectivity Proto Client 145 and LAN Connectivity Proto Server 143 on Modem Device 103 is triggered by the client.

Tethered device 105 and Modem Device 103 create (205) a VLAN for new protocol signaling. In accordance with an exemplary embodiment, the VLAN is created upon request of tethered device 105 to Modem Device 103. In accordance with an exemplary embodiment, Modem Device 103 sends a create VLAN command to tethered device 105, and tethered device 105 creates the virtual interface.

Modem Device 103 assigns (207) a private IP address for its signaling virtual interface. In accordance with an exemplary embodiment, the private IP address is an IPv4 address. In accordance with an exemplary embodiment, Modem Device 103 sends an Assign IPv4 address message to the VLAN on tethered device 105 by using a dedicated DHCP pool. Modem Device 103 sends the local DNS for signaling to tethered device 105 so that tethered device 105 can use it to create the VLAN.

Tethered device 105 receives its IP address for signaling via usual means, such as DHCP, and assigns this IP address to the VLAN for signaling. In according with an exemplary embodiment, the IP address is an IPv4 address.

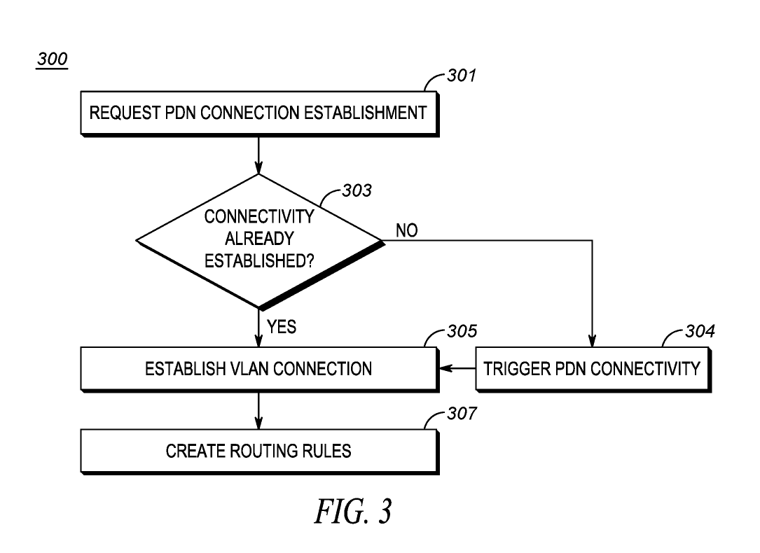

FIG. 3 illustrates a flow chart 300 setting forth process steps for a tethered device to request a PDN connection establishment in accordance with an exemplary embodiment of the present invention.

Tethered device 105 requests (301) a PDN connection establishment, preferably by sending a request to Modem Device 103 over a VLAN. This request may be triggered by an application running on tethered device 105.

Upon receiving the PDN connection establishment request, Modem Device 103 determines (303) whether PDN connectivity is already established. If PDN connectivity is not established, Modem Device 103 triggers (304) PDN connectivity. In an exemplary embodiment, connectivity to the required PDN can be accomplished via Wi-Fi App 121 or via cellular technology, such as LTE. Modem Device 103 alerts tethered device 105 that PDN connectivity has been successfully established.

Modem Device 103 establishes (305) a VLAN connection, such as connection 116 or 117, between Modem Device 103 and tethered device 105, once connectivity to the required PDN is established. When connectivity to the required PDN is established, Modem Device 103 creates a corresponding VLAN on its Modem Device side. In accordance with an exemplary embodiment, an IP address is assigned to the Virtual Interface. DNS-s IP addresses are associated with the VLAN interface on tethered device 105, as well as the IP address. The IP address assignment is based on the NAT configuration or the bridge configuration of this PDN connection on Modem Device 103. In this scenario, the IP address assigned by network 101 is assigned to a first tethered device and a second tethered device is not assigned with an IP address. In the NAT configuration scenario, the VLAN on the first tethered device is assigned with the local IP address from the pool corresponding to this PDN connection. In the bridge scenario, the network assigned IP address corresponding to the PDN connection is passed to tethered device 105.

Modem Device 103 creates (307) routing rules for the VLAN connection. In a first exemplary embodiment, a routing rule is to pass traffic from the VLAN to the corresponding PDN connection and back. This is preferably based on an IP routing table that is associated with the VLAN, since a PDN connection may be shared by multiple tethered devices via a NAT.

At some point, tethered device 105 can ask to have the PDN connection released. Tethered device 105 sends a release message to Modem Device 103. Modem Device 103 analyzes whether such connectivity is used only by tethered device 105. If no other VLAN is routed to this PDN connection and no application on Modem Device 103 uses this PDN connection and this PDN connection is not the last PDN connection, Modem Device 103 releases the PDN connection. Modem Device 103 removes the VLAN corresponding to tethered device 105 and the PDN connection. Modem Device 103 also preferably sends a Connectivity Release event to tethered device 105, instructing tethered device 105 to delete the VLAN and empty the corresponding DNS pool and clear the DNS cash corresponding to this VLAN. The releasing of the PDN connection can also be initiated by modem Device 103 or cellular network 101.

An exemplary embodiment thereby provides routing data between a tethered device and a PDN. As used herein the term “routing” refers to receiving an IP data packet on a network interface, deciding where to route the IP data packet, and then send it to the appropriate destination. In addition, the reverse data flow also is included in the term “routing”.

Client App 115 on tethered device 105, for example a Push-to-talk (PTT) app, triggers a connect message to Modem Device 103. In an exemplary embodiment, the connect message is a request that a message be sent to a PDN.

Upon receiving the connect message, Modem Device 103 determines if a connection between tethered device 105 and network 101 is established. If not, Modem Device 103 attempts to establish a PDN connection. Modem Device 103 creates VLAN on its LAN side.

Modem Device 103 sends a create interface message to tethered device 105. Tethered device 105 creates a virtual interface, preferably utilizing a new protocol client that creates the virtual interface. If the creation of the virtual interface fails, tethered device 105 sends a reject message and Modem Device 103 preferably chooses a new VLAN tag.

Modem Device 103 assigns an IP address to the virtual interface on tethered device 105. In accordance with an exemplary embodiment, the IP address is an IPv4 address. The IP address can be, for example, from a dedicated DHCP pool or a cellular technology assigned IPv4 address.

Modem Device 103 sends an assign IP to interface message to tethered device 105. The assign IP to interface message preferably includes the assigned IP address and the DNS addresses assigned to the PDN connection. A new protocol client on tethered device 105 assigns the received IPv4 address to the VLAN and sets this VLAN DNS pool.

Modem Device 103 sets the routing rules for the VLAN. For example, Modem Device 103 routes all non-local traffic from the assigned VLAN to the PTT PDN connection, and all non-local traffic from the PIT PDN connection to the assigned VLAN.

Modem Device 103 sends a connect success message to tethered device 105. Upon receiving the connect success message, tethered device 105 forwards the connect success message to Client App 115. Upon receiving the connect success message, Client App 115 binds its traffic within tethered device 105 to the corresponding VLAN and starts using the dedicated PDN connection.

In accordance with the foregoing, an improved method and device for routing data to and from a tethered device. The tethered device sends a Network type connect message to a modem device to request a PDN connection. Once the connection is established. the modem device creates a Virtual Local Area Network (VLAN) that includes an assigned Internet Protocol (IP) address and a Domain Name System (DNS) address assigned to the PDN connection. The modem device sends an assign IP to interface command to the tethered device, the assign IP to interface command includes the assigned IP address and the DNS address assigned to the PDN connection. The tethered device assigns the received IP address to the VLAN.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized electronic processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising an electronic processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for routing data between a tethered device and a specific Packet Data Networks (PDN) by a modem device, the method comprising:
establishing a connection between the modem device and the specific PDN;
creating, by the modem device, a Virtual Local Area Network (VLAN) between the tethered device and the specific PDN, the VLAN traversing the connection;
assigning, by the modem device, an Internet Protocol (IP) address for the VLAN on the tethered device;
assigning, by the modem device, a Domain Name System (DNS) address of the PDN for the VLAN;
creating a VLAN network interface on the tethered device, the VLAN network interface corresponding to the VLAN;
sending an assign IP to interface command from the modem device to the tethered device, the assign IP to interface command including the assigned IP address and the DNS address; and
assigning the received IP address and DNS address to the VLAN at the tethered device.

2. The method of claim 1, wherein the step of creating the VLAN comprises creating the VLAN upon a request from the tethered device.

3. The method of claim 1, the method further comprising the step of establishing data routing between the tethered device and the PDN via the VLAN.

4. The method of claim 1, the method further comprising the step of establishing data routing between the tethered device and the PDN over a Wide Area Network (WAN) via the modem device.

5. The method of claim 4, the method further comprising the step of releasing the connection over the WAN via the modem device.

6. The method of claim 1, wherein the IP address for the tethered device is an IPv4 address.

7. The method of claim 6, wherein the IPv4 address is assigned from a dedicated IP address pool.

8. The method of claim 6, wherein the IPv4 address is dependent upon a Network Address Translation (NAT) setting for the VLAN.

9. A method of routing data to and from a tethered device comprising:
sending a Packet Data Network (PDN) connect message from a tethered device to a modem device to request a PDN connection;
creating a Virtual Local Area Network (VLAN) by the modem device, the VLAN including an assigned Internet Protocol (IP) address and a Domain Name System (DNS) address assigned to the PDN connection;
sending an assign IP to interface command from the modem device to the tethered device, the assign IP to interface command including the assigned IP address and the DNS address assigned to the PDN connection;
assigning the received IP address to the VLAN at the tethered device;
binding to the VLAN on the tethered device;
sending a first data packet by an application on the tethered device;
creating routing rules settings for the VLAN; and
routing an IP packet received from the tethered device over the VLAN.

10. The method of claim 9, the method further comprising the step of creating a virtual interface on the tethered device.

11. The method of claim 9, the method further comprising the step of binding traffic within the tethered device to the VLAN.

12. The method of claim 9, wherein the step of creating the VLAN comprises creating the VLAN upon a request from the tethered device.

13. The method of claim 9, the method further comprising the step of establishing a connection between the modem device and the PDN, and wherein the VLAN traverses the connection.

14. The method of claim 9, the method further comprising the step of establishing a connection between the modem device and the PDN over a Wide Area Network (WAN) via the modem device, and wherein the VLAN traverses the connection.

15. The method of claim 14, the method further comprising the step of releasing the connection via the modem device.

16. The method of claim 9, wherein the IP address for the tethered device is an IPv4 address.

17. The method of claim 16, wherein the IPv4 address is received dynamically via a local IP address pool.

18. The method of claim 16, wherein the IPv4 address is dependent upon a bridge setting for the VLAN.
